(19) United States
(12) Patent Application Publication
(10) Pub. No.: US 2025/0095014 A1
(43) Pub. Date: Mar. 20, 2025

(54) METHOD AND SYSTEM FOR AUTOMATED REQUEST-FOR-QUOTE (RFQ) SERVICES WITH AUTOMATED MARGIN OPTIMIZATION

(71) Applicant: Overbond Ltd., Toronto (CA)

(72) Inventor: Vuk MAGDELINIC, Toronto (CA)

(21) Appl. No.: 18/813,245

(22) Filed: Aug. 23, 2024

Related U.S. Application Data
(63) Continuation-in-part of application No. 18/811,393, filed on Aug. 21, 2024.
Application No. 18/811,393 is a division of application No. 17/733,470, filed on Apr. 29, 2022.
Application No. 17/733,470 is a continuation of application No. 16/778,926, filed on Jan. 31, 2020, now Pat. No. 11,354,747.
Application No. 16/778,926 is a continuation-in-part of application No. 15/488,721, filed on Apr. 17, 2017, now abandoned.
(60) Provisional application No. 62/323,673, filed on Apr. 16, 2016.

(51) Int. Cl. G06Q 30/0201; G06F 18/214; G06Q 40/06

(52) U.S. Cl. CPC G06Q 30/0206; G06F 18/214; G06Q 30/0201; G06Q 40/06

(57) ABSTRACT

A computer system configured for automating trading of at least one financial instrument, the computer system comprising: one or more processor units, and a memory device comprising memory space with computer-executable instructions, wherein the computer-executable instructions configured to at least: receive an order to purchase the least one financial instrument; determine a price confidence score associated with the least one financial instrument; determine a liquidity bid score associated with the least one financial instrument; determine a liquidity ask score associated with the least one financial instrument; determine an execution score associated with the least one financial instrument; and assign the at least one financial instrument to one of a plurality of tiers based on at least one of the price confidence score, liquidity bid score, liquidity ask score and execution score, wherein one of the plurality of tiers includes the at least one financial instrument that is suitable for automated trading and another one of the plurality of tiers includes the at least one financial instrument that is not suitable for automated trading.

### CROSS-REFERENCE TO RELATED APPLICATIONS

This application is a continuation of U.S. patent application Ser. No. 18/811,393, filed on Aug. 21, 2024, which is a divisional of U.S. patent application Ser. No. 17/733,470, filed on Apr. 29, 2022, which is a continuation of U.S. patent application Ser. No. 16/778,926, filed on Jan. 31, 2020, which is continuation of U.S. patent application Ser. No. 15/488,721, filed on Apr. 17, 2017, which claims priority to U.S. Provisional Application No. 62/323,673 filed on Apr. 16, 2016, the disclosures of which are incorporated herein by reference.

### FIELD

The present disclosure relates to computer-implemented methods and systems for enabling automated request-for-quote (RFQ) services in a trading environment.

### DESCRIPTION

After the 2008 financial crisis, regulators worldwide recognized the need to create a safer banking system. As a result, regulators increased capital requirements and reduced the risk banks are allowed to take, which increased costs for intermediaries. The unintended consequence of these new regulations has been a reduction in liquidity in the bond market. This has resulted in dealers being less willing, or less able, to hold inventories, and therefore less willing to act as a principal in bond trading.

These structural changes have reduced the ability of the fixed income marketplace to operate efficiently. But with the increasing popularity and regulatory acceptance of cloud computing and ever-improving on-demand processing power, it has become plausible and cost-effective to produce real-time AI-driven analytics. As a result, credit workflows are increasingly being automated.

Traders must price RFQs while meeting workflow objectives and facing constraints, such as: the time window within which the trader is supposed to respond to an RFQ is typically around two minutes, however many RFQ's are completed within 30 seconds; the current cover (difference between accepted trade price and next best quote) is typically in the region of 10-20 cents; the trader must deal with approximately 300 to 700 RFQs per day; and on average, around 30%-40% of RFQs are responded to with a hit rate of 10%-12%.

Under the legacy credit trading process, traders receive RFQs from clients through an electronic process or a manual process. In one example, an electronic RFQ is received via a Bloomberg™, iQbonds™, ION™ or similar terminal window. The electronic RFQ windows appear chronologically on top of each other, along with a timer to expiration (usually no more than two minutes). Next, the trader may check a third-party pricing source to validate the pricing on the RFQ or use their judgment to adjust the price higher or lower. The trader then confirms and submits the price based on the third-party pricing source and/or their judgement of the current market conditions (the trader may also allow the RFQ to expire if they are not interested in quoting). The client then accepts or rejects the updated price.

In a manual RFQ conducted via a phone call, the trader checks the price of the security or similar securities on the Bloomberg terminal (or other third-party pricing service) with the ISIN or Ticker. The trader also checks the quotes from other dealers on the terminal and possibly other interdealer pricing sources. The trader then uses their judgment and knowledge to arrive at a price to be quoted. Generally, RFQs that are receive via the telephone are prioritized, and RFQs received electronically are put on hold until a quote has been given.

When the trader receives the RFQ (electronically or manually), the main ways they can price the bond are to consider indicative quotes from Bloomberg CBBT, iQbonds or similar, firm quotes from interdealer screens and trading venues, modelled pricing from external providers and internal pricing models/guidance or methodology. Inventory will also play a part as the trader may skew the price towards a specific direction (e.g. towards buying or selling) if they have an existing book position. Additionally market quote convention differs, hence the trader may adjust the price, the yield or the relevant spread against a chosen reference rate. Accordingly, the trader must decide which of these methods should be used on a case-by-case basis. In some instances, RFQs may trade away due to the manual and time-consuming nature of checking fixed yields/prices, certain spread ranges or comparing the bond to similar bonds. In one example, the price provided by Bloomberg Composite Bloomberg Bond Trader (CBBT) is a composite price based on the most relevant executable quotations on Bloomberg's fixed income trading platform. The composite is based on current market activity for the bond, so if the bond is illiquid the CBBT price will not represent the true price. This is especially the case when dealing with high yield bonds or bonds with varying liquidity profiles. As such, there is low confidence in prices suggested by Bloomberg CBBT and other third-party applications.

Other third-party pricing providers use a pricing methodology that is based on a specific pre-defined method. However, the trader's confidence in such methods is relatively low as the pricing methodology is not dynamic, which may lead to the suggested pricing being incorrect. Upon executing the trade, the trader can observe the cover price (the second best price), which may typically be 10-20 cents away for an Investment Grade bond (i.e. the trader could have paid significantly less to win the RFQ). These factors lead to low confidence in the suggested prices, and traders must constantly spend a great deal of time and effort manually adjusting prices based on prior knowledge and intuition. The major trade-off is thus accuracy versus time, leading to missed deals and direct downward pressure on desk profit and loss (P&L).

Electronic trading within the Fixed Income space has evolved dramatically over the last few years, the prevalence of All to All platforms has increased to complement the existing RFQ infrastructure and volumes executed via electronic platforms continue to rise, with 62% of European Investment Grade bonds now executed electronically and 49% of High Yield bonds (within Europe).

In the FxMarket, approximately 60% of the market is also electronically executed (although the notional size tends to be much larger) and in recent years innovation has flat lined, with electronic volumes (as a percentage of the overall market) remaining fairly constant.

In markets such as Fx the concept of an Order Router is known it allows the trader to see all the available liquidity and break orders up into smaller chunks, which then feed to multiple venues. Spreads are typically much tighter, however the desire to leave orders to achieve specific price targets still remains.

In some respects the Fixed Income world shares many characteristics with other markets, ultimately when a trader needs to execute a trade the questions they ask themselves are always the same: can I trade at my desired price? can I trade in my desired size? or can I trade within my desired timescale?

In the Fixed Income world (and particularly in Credit) RFQ and instant messaging platforms are the preferred execution venues, however due to liquidity constraints and historic market conventions it can be difficult to achieve best execution on larger sizes, particularly if near instantaneous execution is required.

### SUMMARY

In one of its aspects, a computer system comprising:
one or more processor units, and a memory device comprising memory space with computer-executable instructions;
a data preparation module comprising computer-executable instructions configured to aggregate raw data and normalize the raw data to generate at least one structured dataset;
a pricing module comprising computer-executable instructions configured to determine a first set of features from the at least one structured dataset, the pricing module applying a machine learning architecture to train a set of predictive pricing models to generate an indication in electronic form representing at least one optimal pricing of at least one financial instrument;
a margin optimization module comprising computer-executable instructions configured to determine a second set of features from the at least one structured dataset, the margin optimization module applying the architecture machine learning architecture to train a set of predictive models to minimize a transaction margin for the at least one financial instrument based on one of the at least one of the second set of features and at least one optimal pricing of at least one financial instrument; and
wherein the one or more processor units, and the memory device are configured to write an indication to the memory space to at least communicate the at least one optimal pricing and the transaction margin of the at least one financial instrument via a communication network and/or generate a visual indicator related to and based at least in part on the generated indication on a graphical user interface.

In another of its aspects, a computer system configured for automating trading of at least one financial instrument, the computer system comprising:
one or more processor units, and a memory device comprising memory space with computer-executable instructions, wherein the computer-executable instructions configured to at least:
receive an order to purchase the least one financial instrument;
determine a price confidence score associated with the least one financial instrument;
determine a liquidity bid score associated with the least one financial instrument;
determine a liquidity ask score associated with the least one financial instrument;
determine an execution score associated with the least one financial instrument; and
assign the at least one financial instrument to one of a plurality of tiers based on at least one of the price confidence score, liquidity bid score, liquidity ask score and execution score, wherein one of the plurality of tiers includes the at least one financial instrument that is suitable for automated trading and another one of the plurality of tiers includes the at least one financial instrument that is not suitable for automated trading.

### BRIEF DESCRIPTION OF THE DRAWINGS

Several exemplary embodiments of the present disclosure will now be described, by way of example only, with reference to the appended drawings in which:

FIG. 1 shows an operating environment for a computer system for RFQ automation;

FIG. 2 shows a flow chart outlining exemplary steps implemented by a data preparation module;

FIG. 3 shows an example dataset for input into a machine learning model;

FIG. 4a shows an overview of a workflow for a training process for a model for predicting a price of a financial instrument.

FIG. 4b shows a flow chart outlining exemplary steps for generating a trained predictive pricing model;

FIG. 4c shows a flow chart outlining exemplary steps for generating a trained margin optimization model;

FIG. 5a with partial views FIGS. 5a (i) and 5a (ii) shows results of the margin optimization module;

FIG. 5b shows a user interface 410 of the RFQ viewer for viewing the layer 2 responses;

FIG. 5c shows a portfolio view;

FIG. 6 shows a flow chart outlining exemplary steps for constructing an order routing model;

FIG. 7 shows routing options;

FIG. 8 shows example results presented to a user or trader via a user interface; and

FIG. 9 shows a correlation between the pricing model and observed market pricing.

### DETAILED DESCRIPTION

The detailed description of exemplary embodiments of the invention herein makes reference to the accompanying block diagrams and schematic diagrams, which show the exemplary embodiment by way of illustration. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented.

Moreover, it should be appreciated that the particular implementations shown and described herein are illustrative of the invention and its best mode and are not intended to otherwise limit the scope of the present disclosure in any way. Connecting lines shown in the various figures contained herein are intended to represent exemplary functional relationships and/or physical couplings between the various elements. It should be noted that many alternative or additional functional relationships or physical connections may be present in a practical system.

### Definitions

Transaction Data: Information about executed trades including details such as the security traded, transaction date and time, transaction price, quantity, parties involved (can be anonymized), cover price (the second best price submitted), and any other transaction related data.

Non-binding Quote Data: Real-time indicative quotes across multiple currencies and sectors are used to assess market conditions.

Firm Quote Data: Bid/Ask prices that a party is committed to trade on (the distinction between a firm and an indicative or non-binding quote is that the latter only provides an indication of the liquidity on offer, whereas once a quote is firm the client would assume the dealer trade at the indicated level and size).

Target: In machine learning, the term “target” refers to the variable or feature that a model is trying to predict or estimate.

Feature: A feature refers to an individual measurable property or characteristic of a data point. Features are variables that are used as inputs to a machine learning model to make predictions or classify data

Covered Price: The second best price submitted by a market maker in response to an incoming RFQ submitted by a buy side client (i.e. if dealer A submits a bid price of 97 and wins the trade, then assuming dealer B had submitted the next best price of 96.95 that would be the cover price).

Bid-Ask Spread: The difference between the highest price a market maker is willing to buy at (bid price) and the lowest price a market maker is willing to sell at (ask price) for a particular financial instrument.

Hyperparameters: External configuration settings or choices that are set before the training process begins, which define the characteristics and behavior of the model during the learning process but are not learned from the data itself.

Tier: A way of categorising which bonds are likely to have the lowest transaction costs at any given point, this is assigned dynamically at the tick level, based on the Execution score, with a score of greater than 1 being the top tier (Tier 1) and sub 0.5 being in the lowest tier (Tier 3).

Tier 1: A sub-set of bonds are the most likely candidates for fully automated execution; these bonds have the highest count of quotes in Live markets over the last 24 hours, most stable bid-ask (and relatively tight bid-ask) spread.

Tier 2: A lower tier of bonds suitable for auto-execution (i.e. they are likely to require some manual oversight to ensure best execution is achieved).

Tier 3: Bonds falling into this tier are less likely to be suitable for auto-execution as there is a lower confidence in the ability to determine the best executable price.

Axe: When a dealer indicates their intent, i.e. if a dealer is long (i.e. they own bonds) they would indicate they are an axed seller (i.e. they are looking to reduce inventory), conversely, if they are short then they would indicate they are looking to cover the short and buy bonds.

All-to-All: This refers to a unique electronic protocol where buy side participants can send an RFQ ticket to all users of the service as opposed to manually selecting a smaller number of participants.

Terms & Conditions Data: This is also known as ‘static’ data, however despite this, it can change, it includes features of the bond such as maturity date, coupon amount, coupon frequency, sector, country etc.

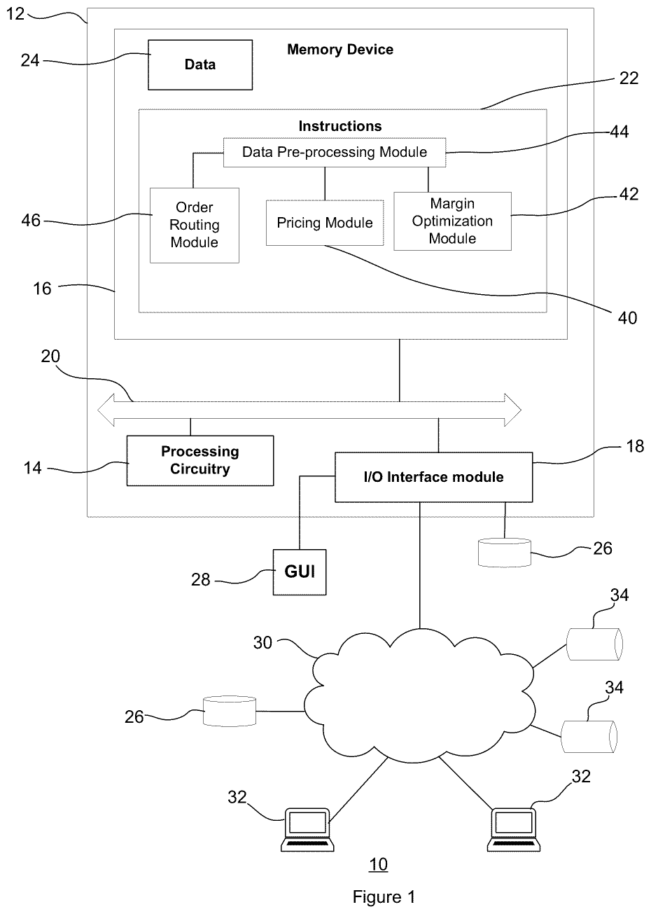

FIG. 1 shows an overview of a computer system 10 for RFQ automation. In one example, the computer system 10 performs market analysis, data aggregation and normalization, and deep artificial intelligence (AI) quantitative observation on a plurality of corporate bonds and fixed income ETFs. The system 10 includes advanced analytics such as price discovery, liquidity risk management, intelligence gathering, pre-trade and post-trade analytics, that may enable trade automation, enhance trade performance and maximize portfolio returns.

System 10 comprises computing means with computing system 12 comprising processing circuitry such as processor 14, at least one memory device such as memory 16, input/output (I/O) module 18, which are in communication with each other via centralized circuit system 20. Although computing system 12 is depicted to include only one processor 14, computing system 12 may include a number of processors therein. In an embodiment, memory 16 is capable of storing machine executable instructions 22, and data 24, including data models and process models. Data repository 26 is coupled to computing system 12 and stores pre-processed data, model output data and audit data. Further, the processor 14 is capable of executing the instructions in memory 16 to implement aspects of processes described herein. For example, processor 14 may be embodied as an executor of software instructions, wherein the software instructions may specifically configure processor 14 to perform algorithms and/or operations described herein when the software instructions are executed. Alternatively, processor 14 may be configured to execute hard-coded functionality. Computer system 10 may be software (e.g., code segments compiled into machine code), hardware, embedded firmware, or a combination of software and hardware, according to various embodiments.

Examples of the I/O module 18 include, but are not limited to, an input interface and/or an output interface. Some examples of the input interface may include, but are not limited to, a keyboard, a mouse, a joystick, a keypad, a touch screen. Some examples of the output interface may include, but are not limited to, a microphone, a speaker, a ringer, a graphical user interface 28. In an example embodiment, processor 14 may include I/O circuitry configured to control at least some functions of one or more elements of I/O module 18, such as, for example, a speaker, a microphone, a display 28, and/or the like. Processor 14 and/or the I/O circuitry may be configured to control one or more functions of the one or more elements of I/O module 18 through computer program instructions, for example, software and/or firmware, stored on a memory, for example, the memory 16, and/or the like, accessible to the processor 14.

A communication interface associated with the I/O module 18 enables computing system 12 to communicate with other entities over various types of wired, wireless or combinations of wired and wireless networks 30, such as for example, the Internet. The communication interface facilitates communication between the computing system 12 and I/O peripherals. In at least one example embodiment, the communication interface includes a transceiver circuitry configured to enable transmission and reception of data signals over the various types of communication networks. In some embodiments, the communication interface may include appropriate data compression and encoding mechanisms for securely transmitting and receiving data over the communication networks.

Centralized circuit system 20 may be various devices configured to, among other things, provide or enable communication between the components (14-18) of computing system 12. In certain embodiments, centralized circuit system 20 may be a central printed circuit board (PCB) such as a motherboard, a main board, a system board, or a logic board. Centralized circuit system 20 may also, or alternatively, include other printed circuit assemblies (PCAs), communication channel media or bus.

A plurality of user computing devices 32 and data sources 34 are coupled to computing system 12 with a communication network 30. User computing devices 24 can therefore access system 10 to run queries and receive requested market insights and predictions based on financial market data from data sources 34. System 10 can be operable to register and authenticate users (using a login, unique identifier, and password for example) prior to providing access to applications, a local network, network resources, other networks and network security devices.

In an example of a sell side offering, the processor 14 can execute instructions in memory 16 to configure pricing module 40, and margin optimization module 42. In more detail, pricing module 40 and margin optimization module 42 comprise a suite of predictive algorithms which receive pre-processed data derived from a plurality of raw data sources 34. Processor 14 is configured by the machine executable instructions to receive input data for processing by the pricing module 40 using data models to determine new optimal prices for financial instruments, for example, new issue bond prices and secondary market bond prices for global investment grade (IG) and high yield (HY) bonds. Other example financial instruments may include currency; debt; loans; equity: shares; derivatives: options, futures, and forwards. Processor 14 is also configured by the machine executable instructions to receive input data for processing by the margin optimization module 42 using data models to minimize a transaction margin with respect to trade information at the point of execution.

The pricing module 40, such as the Corporate and Government Bond Intelligence (COBI)-Pricing model from Overbond Ltd, Toronto, Canada, assists traders in automating pricing and trading workflows for financial instruments, such as global investment-grade bonds. In one example, the pricing module 40 comprises a suite of machine learning (ML) algorithms for the fixed income capital markets. The pricing module 40 algorithmically finds the optimal prices for financial instruments, such as, new issue bond prices and secondary market bond prices for global investment grade (IG) and high yield (HY) bonds. In one example, the ML algorithms analyze millions of data points related to factors such as historical pricing trends between similar bonds and similar issuers, intra-day pricing volatility, trading volume and counterparty composition, company fundamentals, investor sentiment and industry, rating or tenor cluster comparables. The data is aggregated from multiple types of data sources 34, including: transactions data which includes transactions occurring in the secondary market and historical issuance spreads; investment banking data which includes fundamentals on corporations, balance sheet indicators, proprietary data sets, such as dealer quotations and trade points; client book data, and direct access to a large community of issuers and institutional investors via established feedback loops. In one example, the pricing module 40 can generate prices and liquidity scores for more than 100,000 fixed income instruments and can build curves for more than 10,000 issuers in various real-time liquidity scenarios.

The ML algorithms associated with the pricing module 40 ingest, aggregate and process data from live and historical vendor feeds, internal historical records, over-the-counter (OTC) settlement layer volume records, and voice transactions. The pricing module 40 outputs pricing and liquidity scores in real-time for live trading automation, and routing algorithms can capitalize on all primary and agency trading routes, voice or electronic, across all venues and counterparty types.

In one example, the pricing module 40 has a refresh rate of less than three seconds, enabling sell-side trading desks to fully automate 30% of their RFQs and execute an additional 20% with trader supervision. In one example, when new quotes are received from the data stream, the cleaning process takes about 1 second. After cleansing, the model takes about 1.4 seconds to compute prices for each aggressiveness level. The pricing module 40 allows traders to automate trade flow, improve liquidity risk, improve price monitoring and reporting, respond to 80% to 120% more RFQs, maintain an optimal hit ratio and significantly increase desk P&L.

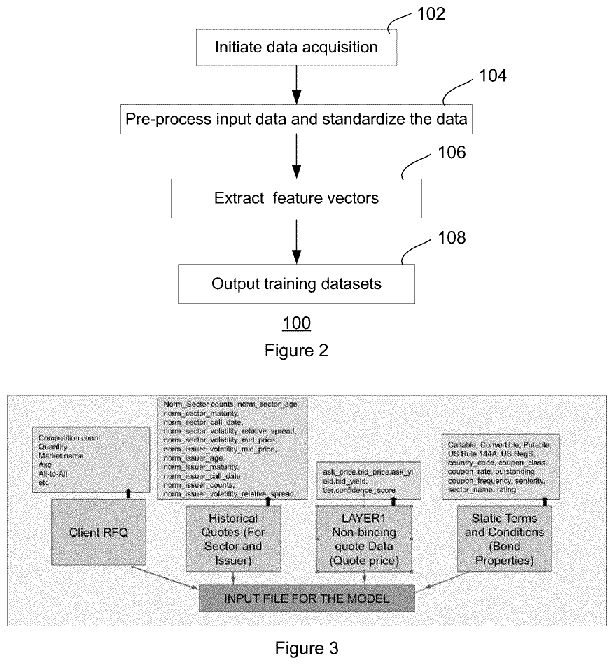

FIG. 2 shows a flow chart 100 outlining exemplary steps for acquiring raw data and preparing data for input into predictive models associated with the various modules of the system 10, such as the pricing module 40 and the margin optimization module 42.

In step 102, the pricing module 40 sources fundamental live raw trading data 24 from a plurality of data sources 34. The data sources 34 may include Refinitiv, Ice, The Six Group, EDI, MarketAxess, Tradeweb, Euroclear, Clearstream, DTCC, CDS, S&P Global Market Intelligence, major credit rating agencies, as well as other sources. Thomson Reuters (primary and secondary bond issuance and trading levels, secondary pricing data, outstanding securities, historical bond issuance), DBRA, S&P, Moody's, Fitch (company ratings, company credit rating, and macro market data), Thomson Reuters (company sector information, Central Banks/Treasuries, public sources (Macro Market Data), including various other sources.

The raw financial data may also include industry sector comparables (such as comparable securities from the same sector), settlement data, trade reporting data and proprietary data. Additionally when requesting a streaming quote from a streaming model (Layer 1) a security identifier must be specified, whereas for an invocation quote from an invocation model (Layer 2) a security identifier, trade size, trade venue, dealers in competition must be specified (default values can be used for all apart from the security identifier). In addition the user can specify whether an RFQ is to be executed via an ‘All to All’ platform (i.e. a protocol where the ticket is shown to a large number of participants, rather than just a select few) and for sell-side desks whether an existing axe is in place (i.e. whether the trader is long a security and looking to sell or short and looking to buy).

Layer 1 pricing (also known as ‘Pre-trade model’) is a streaming service that supplies a data feed containing modelled prices in near real-time, along with analytics. The price is not specific to a particular protocol (such as RFQ) and no size adjustment is made (i.e. it is a generic price). The pre-trade model used in COBI Layer 1+ pricing model is designed to predict the bid-ask spread, defined as the difference between the quoted ask and bid prices. In one example, the pre-trade model leverages a comprehensive dataset of valid historical quotes, such as, quotes from Overbond's managed pool of 25,000 bonds. The pre-trade model pool includes corporate benchmarks across all standard tenors, sibling bonds from major issuers, and other tracked bonds.

In one example, the pre-trade model applies a boosting algorithm that learns from historical pricing trends, captures industry events from benchmark activities, and considers the effects from the relative issuers. This approach ensures a more stabilized pricing curve compared to raw quotes from various platforms. Layer 1+ COBI pricing offers real-time pricing generation and more accurate price prediction checks using executed prices from sources such as TRACE and Propellant. This enhances the reliability and precision of the bond pricing strategy, providing market participants with actionable insights and a competitive edge in bond trading.

Layer 2 pricing is an invocation service that supplies data when invoked by the client. The client has the ability to specify characteristics such as size, dealer count, trading venue (as the default assumption for this model is that the client is likely to initiate an RFQ). Additionally the AI size adjustment is run post process to optimize the price for the chosen size. Layer 2 uses additional features on top of those included in Layer 1, these are all explained in the attached document.

The pre-trade model in Layer 1+ operates similarly to the Layer 2 margin model. The Layer 1+ model uses raw non-binding quote data, such as real-time indicative quotes across multiple currencies and sectors are used to assess market conditions and daily refreshed terms & conditions data, which comprises up-to-date data recordings of the bond issuance properties. The pre-trade model leverages over two years of historical quotes data, allowing for extensive training and robust predictions. The predicted prices are subsequently adjusted by considering external information such as quote size and quotes from other platforms.

The Layer 1+ process uses non-binding quote data to calculate features at three levels, such as, bond, issuer, and sector. These features are then used to predict the corresponding bid-ask spread using the boosting method. In one example, the COBI predicted prices are categorized into three tiers based on their confidence and liquidity scores, such as: Tier 1: Highest confidence and liquidity, suitable for direct use in trade automation; Tier 2: Moderate confidence and liquidity, suitable for reference prices; and Tier 3: Low confidence and liquidity, requiring careful use.

The confidence score measures the reliability of the corresponding COBI price, calculated based on three factors from the last business day, such as, Quote Count: Number of quotes available; Price Volatility: Volatility of the quote prices and Spread Volatility: Volatility of the quote spread. These factors are normalized by sector level. Lower quote counts or higher volatilities result in lower confidence scores.

The liquidity score measures how quickly a bond can be traded at a stable price. The liquidity score is derived from at least the following: Monthly Trade Count: Frequency of trades within a month; and Weighted Average Daily Volume per Trade: Average volume of trades per day. Bonds with more frequent trades and higher trading volumes have higher liquidity scores.

The execution score combines the confidence and liquidity scores using a weighted sum. Higher execution scores indicate higher reliability and are likely to be in higher tiers. The final tiering is also adjusted based on model statistics. The prices are categorized into three aggressive levels, and a narrow price range between the most aggressive and conservative levels results in higher reliability and tiering.

The COBI pre-trade model generates prices whenever a new quote is available, as post-process adjustments. Generally, adjustments are necessary when the pricing time differs from the latest quote time. To adjust the confidence score over time, a time decay process is applied. The time decal process calculates the time difference between the pricing time and the latest quote time, reducing the confidence score as time passes, which subsequently affects the execution score and tiering. When no new quotes are available since the last one, model prices are adjusted based on changes in government benchmarks, via a benchmark invocation process. Assuming the credit spread remains unchanged, the new COBI price is adjusted by adding the same credit spread to the new benchmark yield.

As such, the COBI Layer 1+ process provides a robust system for predicting bond prices and assessing their reliability. By incorporating real-time data and sophisticated modeling techniques, it ensures accurate and dependable pricing for various market conditions. The tiering process further enhances reliability by categorizing prices based on confidence and liquidity, ensuring optimal use in trade automation and reference pricing.

Table 1 shows examples of confidence and liquidity scores; and time decay adjustments.

TABLE 1
Confidence and Liquidity Scores (Example
1); and Example 2: Time Decay Adjustment

| | Bond A | Bond B |
|---|---|---|
| Quote Count | 45 | 5 |
| Price Volatility | Low | High |
| Spread Volatility | Low | High |
| Trade Count | High | Low |
| Daily Volume | High | Low |
| Result: | High confidence | Low confidence |
| | and liquidity | and liquidity |
| | scores, Tier 1. | scores, Tier 3. |

| | Bond C: Last quote was 1 hour ago. The |
|---|---|
| | confidence score decreases by 7% per hour. |
| Initial Confidence | 1.20 |
| Score: | |
| Adjusted Confidence | 1.15 (after 1 hour) |
| Score: | |

Example data used by the pricing module 40 is shown in Table 2 below:

TABLE 2

| Pre-processed | | Update | |
|---|---|---|---|
| Data | Source | Frequency | Relevance |
| Neptune streaming | Neptune | Real-time | Provides real-time dealer ‘axe’ data |
| axes | | | (this shows whether dealers are |
| | | | looking to buy or sell and in what |
| | | | size and price). It is used in post |
| | | | processing to adjust the model |
| | | | price, confidence score, liquidity |
| | | | score, execution score ad tiering |
| | | | and is client specific. |
| Real-time | Refinitiv | Real-time | This is the base source for the |
| streaming prices | | | modelled pricing. The model then |
| | | | outputs a spread to apply to this raw |
| | | | price. |
| Settlement layer | Euroclear, | Intraday, | Settlement layer data, when |
| data per ISIN | Clearstream, | end-of-day | adjusted and merged with the |
| liquidity profile | DTCC, | and historical | correct trading time stamp, can |
| | CDS, MiFID II | | augment the view into the true |
| | reported data | | liquidity of the particular ISIN as it |
| | via Propellant | | contains settled trades by |
| | | | counterparties that were executed |
| | | | over-the-counter (OTC) and |
| | | | otherwise do not appear in other |
| | | | consolidated data feeds. |
| Client Trade | Client | Weekly when | This is used to train an initial model |
| History | Provided | in | for a client and then updated data is |
| | | production, | used to tune the model post go-live. |
| | | otherwise on | This is typically done on a monthly |
| | | an ad-hoc | basis. |
| | | basis. | |
| Live Venue prices | UBS | Real-time | These are used as inputs for the |
| | Bondport, | | SOR model, to highlight current |
| | Tradweb | | tradeable prices in the market to |
| | | | users. |
| Terms & | Refinitiv | Daily Update | These are updated as part of an |
| Conditions Data | | | overnight batch process and are |
| | | | essential for correct feature |
| | | | generation. |
| ETF Constituent | Blackrock | Daily Update | The ETF constituents of selected |
| Updates | iShares | | ETF's are updated and used as |
| | | | benchmark bonds (i.e. a set of |
| | | | bonds against which other bonds |
| | | | can be compared) |

The data repository 26 is updated periodically, or refreshed, with the most recent and updated information or raw data available from different sources, as discussed above. Examples of raw data include: (a) static terms and conditions data, which comprises the data regarding static properties of all the securities that are of interest to the client, such as coupon rate, coupon class, maturity date, callable, etc; the properties of the existing lists of securities are monitored on an ongoing basis to detect any changes, and any new securities may be added accordingly; (b) quote data, which includes the quote data for government and sector benchmark securities and securities of issuers (bond issuer) of interest; and (c) client RFQ (transaction) data, which may be added to data repository 26 as per client's need; the client RFQ (transaction) data may be used for incremental training of our model, and may be updated weekly, monthly, or quarterly depending on the requirements.

In step 104, the data pre-processing module 44 receives the raw data and structures and scrubs the data for anomalies and null values, and standardizes the raw data. For example, trades that are either missing model features or are considered to be an outliers are identified and removed.

In step 106, features of the data are extracted from the data 24 and converted to a numeric value. As such, the raw data is transformed into different formats such as, binary, categorical (more numeric values than just binary), and continuous (features with decimal values and a range) to get these numeric values. These features include, but are not limited to, factors that measure secondary market spread movements, recent issuance pricing levels, nearest neighbor credit ratings and fundamental financial metrics. These factors are then divided into sector and company-specific factors and are used as inputs to the machine learning models. As shown in FIG. 3, a dataset for input into the machine learning models may include features of the standardized data, such as client RFQ data, historical quotes, layer 1 non-binding quote data and static terms and conditions.

In step 108, one or input datasets are output for eventual training of the various models associated with the various module of the system 10, such as the pricing module 40 and the margin optimization module 42.

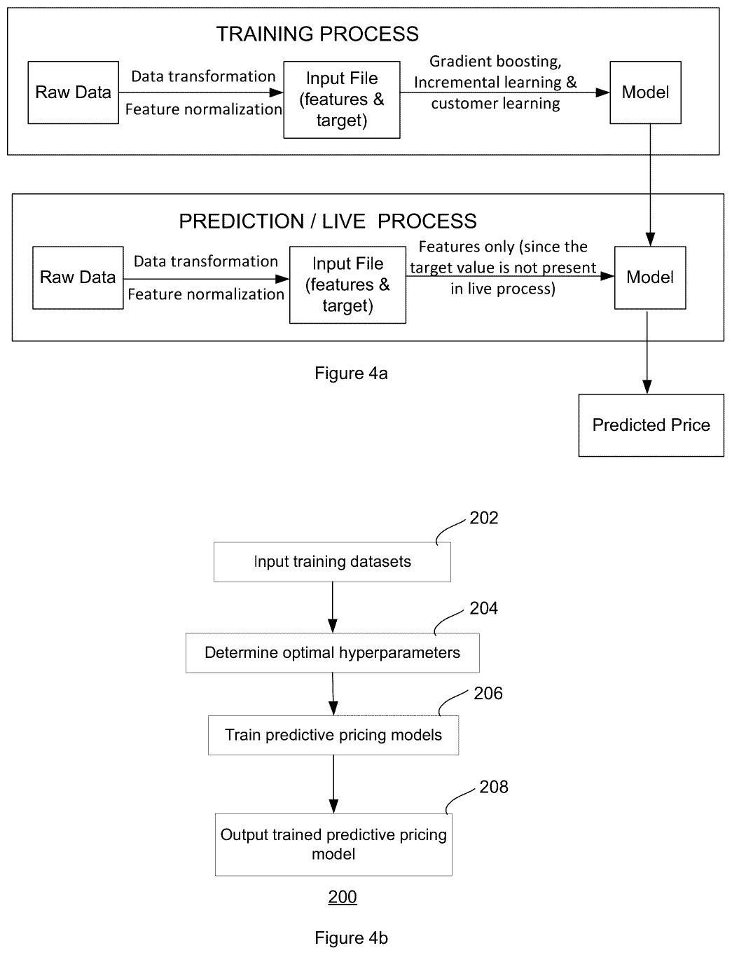

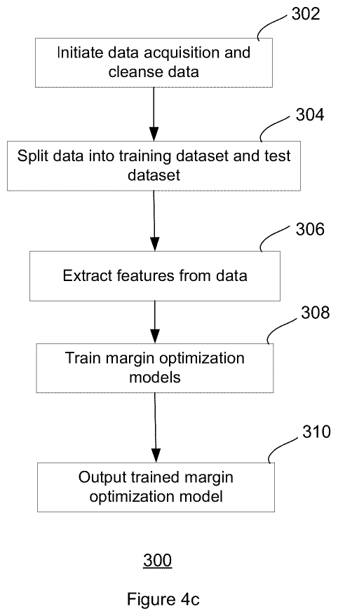

FIG. 4a shows an overview of a workflow for a training process for a model for predicting a price of a financial instrument, the steps for which are described in more detail below.

FIG. 4b shows a flow chart 200 outlining exemplary steps for generating a trained predictive pricing model associated with the pricing module 40.

In step 202, input training datasets are fed into the predictive pricing model.

In step 204, instructions are executed by the processing circuitry 14 to determine the optimal hyperparameters for the price prediction model.

In step 206, the training data set and the feature vectors are used to fully train one or more predictive pricing models associated with the pricing module 40. In one example, different machine learning classifiers or algorithms are used for building the predictive models, such as, supervised learning algorithms, unsupervised learning algorithms and reinforcement learning algorithms. Examples of supervised learning algorithm systems include support vector machine, decision tree, linear regression, logistic regression, naive Bayes, k-nearest neighbor, random forest, AdaBoost, XGBoost, and neural network methods. Examples of unsupervised learning algorithm systems include K-means, mean shift, affinity propagation, hierarchical clustering, DBSCAN (density-based spatial clustering of applications with noise), Gaussian mixture modeling, Markov random fields, ISODATA (iterative self-organizing data), and fuzzy C-means systems. Examples of reinforcement learning algorithm systems include Maja and Teaching-Box systems. Generally, training the predictive models involves optimizing the parameters of a predictive system to minimize the loss function. In addition to the training step, the predictive models also undergo validation using test datasets.

In one example, an ensemble learning strategy is used in three phases, meaning multiple models are combined to elevate the overall robustness at each training stage. These models are each trained using subsets of past data that range from one day to a maximum of ten years. Advanced sampling techniques are used to account for illiquid issuers' data gaps to construct yield curves for all tenors and all issuers in the coverage universe.

The model may be retrained periodically to improve the model's performance, such as, when there is an availability of new data. For example, the new data may include new securities or any change in existing securities. The model may also be re-trained by incorporating new techniques, algorithms, or features to achieve better accuracy. In some cases, models may suffer from performance degradation over time due to factors such as overfitting or underfitting. Overfitting is the scenario where the model becomes too specific and fails to generalize, whereas underfitting is the scenario where the model becomes too general and compromises on accuracy. Therefore, retraining may be performed to minimize these issues.

The model's hyperparameters and penalty functions may also be adjusted or re-tuned, in order to improve model's performance in order to minimize model degradation over time. This may be implemented by setting up thresholds for the predicted price. If the predicted price is deemed to be an outlier (based on being outside tolerance) compared to current market quotes it would trigger an alarm (notification). If multiple alarm breaches are observed in a short span of time, a retuning may be required.

In step 208, a trained predictive pricing model is outputted.

In operation the trained predictive pricing model may receive an input file obtained from raw data having undergone data normalization and feature normalization, as described above, and outputs a predicted price. As such, the predictive pricing model can thus be used on live data to make price predictions in real-time.

As the model runs continuously in service, the predicted price values may be logged to record the model coverage in the background. The recorded data may be audited and analyzed periodically to determine the efficacy and accuracy of the model. If any abnormal behavior is observed from the model, re-training and re-tuning of the model may be conducted. Auditing and reporting may be performed done in a periodic manner (once every quarter), but it can additionally be carried out on demand.

The margin optimization module 42 comprises margin optimization AI models which measure the distance to cover on all prior executed transactions and RFQs and minimizes it with respect to trade information at the point of execution. As a result, sell-side market-making desks can double or triple the volume of RFQs they can respond to without incurring negative margin on those trades and increase profitability in an environment where it is becoming increasingly difficult. The margin optimization models incorporate a variety of factors as inputs to the AI ensemble to arrive at a distance to cover price for each transaction. The models aim to capture and convert various margin optimization measures to one unified, optimized distance to cover price. These distance-to-cover metric factors include but are not limited to the following: bid/ask spread-which captures the transaction cost of a secondary trade; tenor, which assesses the time remaining before the bond's expiration date; number of dealer competitors to assess the competitiveness of the market situation indirect measure of market depth that captures the availability of market making for that bond; and trade size/quantity to assess the volume generated by each trade. In one example, the bond buyer matching module output serves as an input for the margin optimization. In one example, the model incorporates over 20 predictive features, many of which are derived transformations of the factors mentioned. For instance, instead of directly using the bid/ask spread as a feature, the model utilizes the normalized volatility of changes in the bid/ask spread. Similarly, for tenor, the model employs the normalized time to maturity, adjusted for sector and issuer-level aggregates. The importance of these features varies depending on the data structure in the training dataset. The model uses a tree-based ensemble method rather than a linear approach, making the concept of individual feature weights inapplicable.

FIG. 4c shows a flow chart 300 outlining exemplary steps for generating a margin optimization model associated with the margin optimization module 42. In step 302, data acquisition is initiated from sources with raw transaction data, such as Trade Reporting and Compliance Engine (TRACE). In one example, principal-based trades with over $100K size are used in the model development, and quote data is added to the transaction data. The quote-associated data may be derived over predetermined periods e.g. 24-hour windows, and the data may be collected for the dates for the normal market conditions. Alternatively, the data may be real-time transaction data. The raw transaction data is subsequently cleansed and normalized, described above.

In step 304, the data is split into a training dataset, and a test dataset. In one example, 75 percent of data is allocated to the training data set and 25 percent of data is used for the test data set.

In step 306, the features of the data are extracted and converted to a numeric value. As such, the raw data is transformed into different formats such as, binary, categorical (more numeric values than just binary), and continuous (features with decimal values and a range) to get these numeric values. For example, categorical features may comprise coupon: coupon frequency, coupon type; optionality: callable, puttable, convertible; regulatory: 144A, Regulation S; and country, seniority (unsecured senior debt). Continuous features may comprise bond specific features: coupon rate, amount outstanding, remaining maturity, age, remaining call date, quote counts, volatility of change in bid-ask spread, volatility of change in mid price; issuer specific features: quote counts by issuer, volatility of change in bid-ask spread by issuer, volatility of change in mid price by issuer; sector specific features: quote counts by sector, volatility of change in bid-ask spread by sector, volatility of change in mid price by sector and trade features: trade size (for the post-trade model). In one example, volatility of change is calculated by obtaining the percentage change compared to the previous quote (where the previous quote is the most recent timestamp prior to the current one) and then grouping by sector and issuer to get the volatility of change for those categories respectively. The features are subsequently normalized, and as the spread generally changes over time, a target value is normalized by the daily median spread of the benchmark, in one example. For example, whether the liquidity (transaction) cost is expensive or cheap is relative to the market cost at the time of a transaction. The target value is normalized by the daily median spread of the benchmark (sector median bid-ask spread as discussed above). Due to different levels of benchmark median bid-ask spread over time, features need to be normalized as well. As such, normalization by the median helps to make the data more robust and less sensitive to extreme values. As such, features may be normalized by the median value of the benchmark e.g. sector-level data normalization of one of the features such as the remaining maturity of the bond would be carried out as follows: remaining maturity of a bond divided by the median remaining maturity of the benchmark.

A boosting algorithm may be employed to model the behavior of the distance between the spread of each bond and the median spread of the benchmark. For example, gradient boosting is a machine learning technique that boosts the effectiveness, precision, and interpretability of a model by using a group of weak learners. In this context, “learners” refer to the individual weak models that are combined to create a stronger ensemble model. The term “weak” in this context refers to the fact that these individual models may have relatively low predictive power on their own, but when combined, they contribute to the overall predictive performance of the Gradient Boosting model. The iterative process of training and combining weak learners achieves higher accuracy compared to using a single strong learner.

Incremental learning techniques are employed, in which a model's knowledge base is updated efficiently as new data becomes available, without the need to retrain it from scratch. Accordingly, the model is trained continuously over time by updating its knowledge and adding more data to the previously trained model. The concept involves using an initial model, such as a pre-trade model built on two years of quote data—and updating it periodically with new (weekly or monthly) data. For example, if a model was initially trained on data from the entire year of 2022, then when adding data from January 2023, the entire model does not need to be trained again, instead the pre-trained model is used and incremented for the additional month. This method maintains or enhances accuracy while handling the increased volume of data over time, thus potentially decreasing the time required for retraining. As a consequence, incremental learning improves memory capacity in the machine learning systems by allowing the models to continuously update and adapt to new information without forgetting or overwriting previously learned knowledge. As such, incremental learning allows the models to process and learn from new data with minimal or reduced computational overhead, and significantly improves performance, learning speed and memory capacity.

Accordingly, the most suitable model may be selected according to the data. In addition, custom penalty functions which rely on a combination of techniques (MSE, Quadratic, Cubic penalties) may be employed to penalize incorrect outcomes and produce the best results. The objective is to estimate prices as close to the cover (second best) price as possible. While the model may produce predictions slightly above or below the cover price, predictions that fall below the cover price are minimized, as such outcomes would result in rejection. To address this concern, custom penalty functions work to significantly penalize predictions lower than the cover price more than those exceeding it. By iteratively training the model with this approach, this reinforces the model's understanding that predicting below the cover price is undesirable.

In one example, the margin optimization model adjusts to the desk's approach by adapting margin based on the availability of a bond in the market and a market risk tolerance. Accordingly, the margin optimization model is trained total market capacity and market risk. Generally, in one example total market capacity (TMC) is reached when there is insufficient bond amount readily available in the market to fill a trade, that is, the portion of the outstanding amount of a bond not tied up by buy-and-hold accounts unwilling to trade. As such, traders are likely to alter their margin for trade sizes approaching TMC. The margin optimization model includes a pre-trade cost model and a post-trade model. The pre-trade cost model captures the behaviors in the market and the weight of features, and ensures the selection of features. The pre-trade model predicts the bid-ask spread of a non-binding quotation. Although, the spread may not consider the size of a trade, the spread is a good indicator of what the price would be at the current conditions. The post-trade cost model in which the trade size is modeled based on the pre-trade model. The post-trade model may be tuned with client RFQ data.

In step 308, the training data set and the feature vectors are used to fully train one or more margin optimization models associated with the margin optimization module 42. As mentioned above, different machine learning classifiers or algorithms are used for building the margin optimization models. To train for TMC, learning and prediction are applied to six or more months of historical data to bridge data delays and discern trade size and volume patterns. For instance, by tracking what's added daily, the algorithm uses TRACE data to determine how much inventory dealers add incrementally over several months.

The margin optimization model may be trained to adapt to market risk conditions at the time of the trade, and to the impact of market conditions on historical margin levels, which entails isolating the effects of individual risk categories reflected in the price of a bond at the time of the historical trades.

The margin optimization model may use case-mix adjusted cluster (CMAC) analysis to separate country, sector, issuer and issue-specific risks in bond prices and isolate market conditions through time. CMAC is used to group similar observations into a group or cluster. So, for instance, all bonds whose prices rise when oil prices fall might be lumped together irrespective of their other characteristics. However, there are other factors that affect bonds. For instance, bonds sensitive to oil prices could include bonds from airlines, manufacturing or trucking, have multiple maturities and be rated differently and the number of clusters of like attributes can quickly become staggering. Accordingly, CMAC analysis adjusts for differences in populations and population size before clustering results according to certain common variables. This might mean adjusting for call features or bond tenor before clustering results according to spread movements.

As such, in one example, the system 10 uses CMAC analysis to remove pricing movements related to risks at the issuer level and isolate the security-specific risk demonstrated in the pricing movement. The main success of applying CMAC analysis is the ability to isolate those attributable pricing movements versus the broader market purely algorithmically.

When training the model, CMAC is applied to a historical series of post-trade data from the desk to determine if trades occurred in a normal, heightened, or low-risk environment. This allows the model to discern the margin patterns attributable to these markets and adjust according to current market conditions. Margin in the automated trading system becomes dynamic and adapts to current market conditions as the trader would.

The “dynamic” nature of the CMAC analysis stems from its two-layered model structure, which adapts specifically to varying client needs and market conditions. The foundational layer (layer 1) calculates market prices and provides insights into factors such as bond liquidity and market price confidence, reflecting the current market conditions. This ensures that the baseline of our analysis is consistently up-to-date with real-time market fluctuations. Building on this, the second layer (layer 2) integrates specific dealer Requests for Quotes (RFQs), which vary according to each dealer's trading behavior—some may be more aggressive, while others are more conservative. This customization allows the CMAC to tailor its output for each client differently, depending on the unique dataset of prices used during training. This tailored approach allows for a more nuanced and client-specific analysis that dynamically adjusts to both the market and individual dealer behaviors. Therefore, the CMAC model's flexibility in adapting to specific RFQs and market conditions provides a clear competitive edge in pricing accuracy and relevance.

The results of AI model for margin optimization minimize the distance-to-cover for every RFQ on top of the best executable price determined by COBI-Pricing model.

In step 310, a trained margin optimization model is outputted.

In operation, in order to auto-respond to an incoming RFQ received at a user device 32, such as a credit trading desk order management system (OMS), several data aggregation, cloud compute and AI modelling services of system 10 are delivered to the sell-side credit trading desk OMS via API data feed, and may include: confidence score, in real time, segregating if RFQ is eligible for auto-response; pricing modeling, extending coverage of RFQs that do not have best executable price from underlying pricing source i.e. Bloomberg, Refinitiv composites; and calculation of auto-margin, margined price and clearing price, and are closest to covers on RFQs accepted historically, for maximum optimised desk P&L.

The confidence score is a relative measurement that provides market activities against corporate benchmark. Generally, tick count per ISIN, volatility of change in bid-ask spread, and volatility of change in mid price are measured over 24 hour windows, and each measurement is normalized against benchmark, and the benchmark is picked per currency. In one example, no price adjustment is required when confidence score is over 1.

However, a price adjustment process applies when the confidence score is below 1 (e.g. Tier 2 and Tier 3 category/market situations). As such, an issuer curve may be built when the number of bond for issuer is more than 3, with the SVM curve fit on the issuer representative bonds. The price is adjusted from issuer curve to raw quote price input (weighted average based on confidence score with modelled curve price and raw composite price as an input). In one example, a nearest neighbor model is applied when the number of bonds for issuer is less than 4 in order to find a proxy curve that fits best. The price is adjusted based on the mean ratio, distance between proxy and the bond (weighted average applied in the similar way as with confidence score in the prior category), and then scaled until a confidence score mid point between close-set peer curve and ISIN at corresponding tenor. Any anomalies in input data may be excluded in the curve construction if wider that 3 standard deviations.

As part of the automated RFQ response, the bid-ask spread is predicted using pre-trade and post-trade data given the market condition. The market condition may be associated with a risk coefficient measurement unit such as: bad, normal and good market condition. Accordingly, the distribution of the spread may be different based on the market condition. The coefficient is measured using pre-trade data, and the total market capacity is added to the model using post-trade data. The model may be tuned with historical book with deal competition from RFQ data to output price closer to cover (not winning RFQ price as it is not efficient frontier)

In one example, a back-test was conducted for a sell-side trading desk that trades in Euro and USD. The trading performance of the margin optimization model was compared with the record of the trading desk without AI assistance, as shown in Table 3.

TABLE 3

| REQUEST_STATUS | ASK | Ratio_ASK(%) | BID | Ratio_BID(%) |
|---|---|---|---|---|
| ACCEPTED | 7,550 | 2.73% | 4,956 | 2.23% |
| ACCEPTED_TIED | 1 | 0.00% | 2 | 0.00% |
| COVERED | 7,163 | 2.59% | 4,335 | 1.95% |
| COVERED_TIED | 27 | 0.01% | 21 | 0.01% |
| CANCELLED | 69 | 0.02% | 91 | 0.04% |
| EXPIRED_CUSTOMER | 7,051 | 2.55% | 5,468 | 2.46% |
| EXPIRED_DEALER | 4,780 | 1.73% | 1,994 | 0.90% |
| INPUT_ERROR | 2 | 0.00% | 3 | 0.00% |
| NO_INTEREST | 2 | 0.00% | 1 | 0.00% |
| PASSED | 25,971 | 9.38% | 15,365 | 6.90% |
| PASSED_UNKNOWN | 665 | 0.24% | 174 | 0.08% |
| REJECTED | 178,325 | 64.38% | 155,936 | 70.06% |
| TIED_TRADED_AWAY | 40 | 0.01% | 32 | 0.01% |
| TRADED_AWAY | 45,329 | 16.37% | 34,209 | 15.37% |
| TOTAL | 276,975 | 100.00 | 222,587 | 100.00 |

All RFQ volumes traded in Q2 and Q3 in 2022 were compared, which included 7,551 accepted (and accepted but tied) RFQs and 7,190 covered (and covered but tied) RFQs on both the bid and ask sides. The trades were filtered to include only 9,704 trades that involved senior unsecured corporate bonds, of which the trading desk accepted 5,083 and the model accepted 3,018, as shown in Table 4.

TABLE 4

| | ASK | BID | Total |
|---|---|---|---|
| Accepted & | 14,741 | 9,314 | 24,055 |
| Covered | | | |
| Non-USD & Non- | (2,556) | (1,611) | (4,167) |
| EUR | | | |
| Non Senior | (974) | (778) | (1,752) |
| Unsecured | | | |
| Non-Corporate | (2,027) | (1,216) | (3,243) |
| Bonds | | | |
| No quotes over last 24 | (1,725) | (929) | (2,654) |
| hours | | | |
| Price to mid spread > 4 × | (2,232) | (303) | (2,535) |
| bid/ask to mid spread | | | |
| Total Exclusion | (9,514) | (4,837) | (14,351) |
| Total Accepted & | 5,227 | 4,477 | 9,704 |
| Covered | | | |
| Accepted Trades | 2,657 | 2,426 | 5,083 |
| Model Accepted | 1,769 | 1,249 | 3,018 |
| Trades | | | |
| Model Accepted / | 66.6% | 51.5% | 59.4% |
| Accepted | | | |

In one example, the margin optimization model was optimized for maximum profit capture or minimum distance-to-cover, so the prices produced by the model would be expected to be closer to cover than those quoted by the trader. The cost of margin for each trade was measured as the distance to cover (in cents) multiplied by the size of the trade (in Euros).

The model additionally looks at the rejected RFQs and based on the proportion falling into the Tier 1 category (the most liquid bonds) then performs a scenario analysis to determine the potential opportunistic P&L capture. Table 5 shows the scenario analysis for actual Q2-Q3 2022 data, along with 3 additional scenarios to highlight the potential variance for portfolios with differing numbers of Tier 1 categorized bonds. Assuming a mid-range 40% increase in hit rate for the book in question, the trader would expect to see an opportunistic annualized P&L gain of over EUR 2 million.

TABLE 5

| Tier 1/Hit | | | | | | | |
|---|---|---|---|---|---|---|---|
| Ratio | 10% | 20% | 30% | 40% | 50% | 60% | 70% |
| 25% | 235,854 | 483,091 | 732,188 | 983,767 | 1,238,473 | 1,492,263 | 1,742,753 |
| 50% | 255,477 | 511,996 | 767,866 | 1,020,737 | 1,277,461 | 1,535,950 | 1,790,523 |
| 75% | 274,112 | 540,097 | 801,712 | 1,058,572 | 1,319,876 | 1,578,892 | 1,838,231 |
| Q2-Q3 | 255,858 | 512,208 | 767,091 | 1,022,055 | 1,278,889 | 1,535,989 | 1,791,703 |
| Average | | | | | | | |

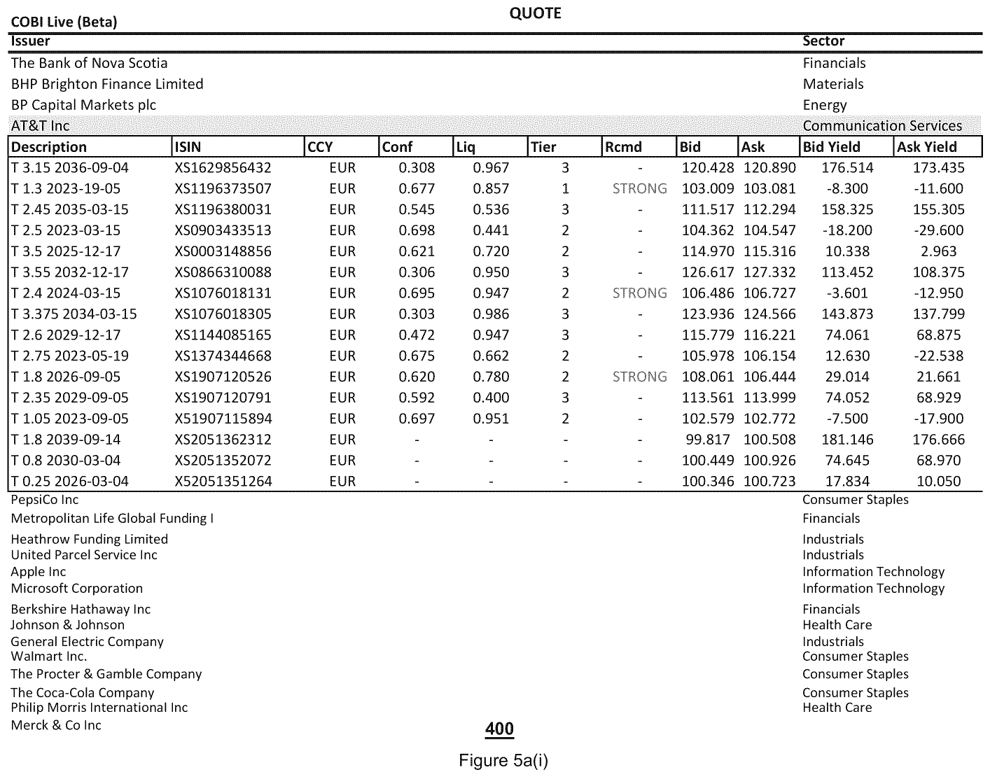

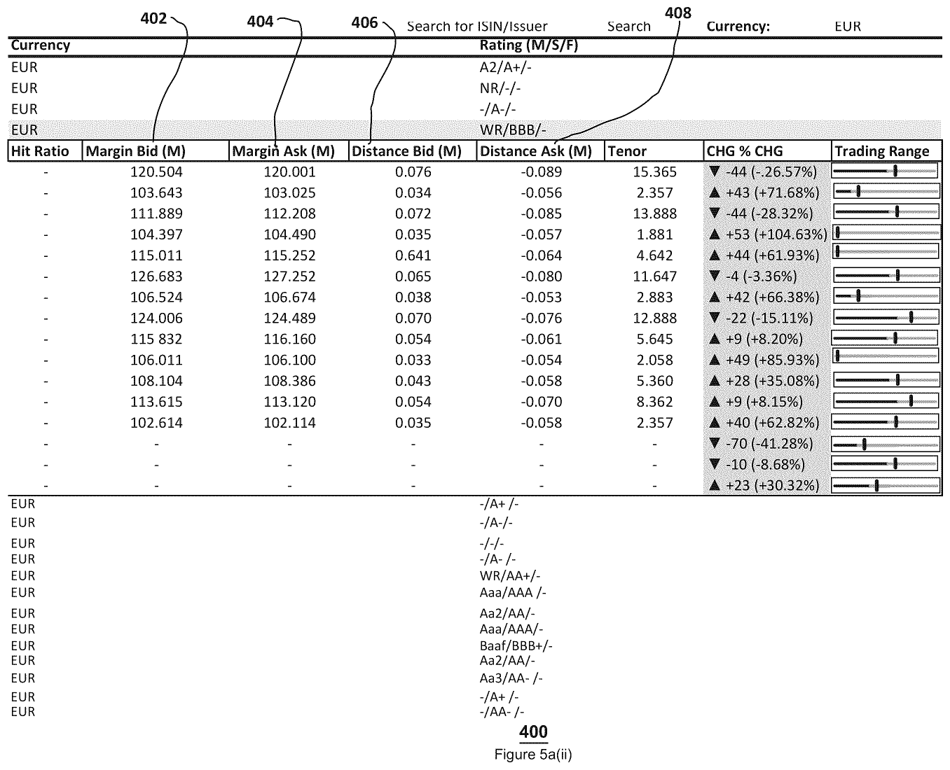

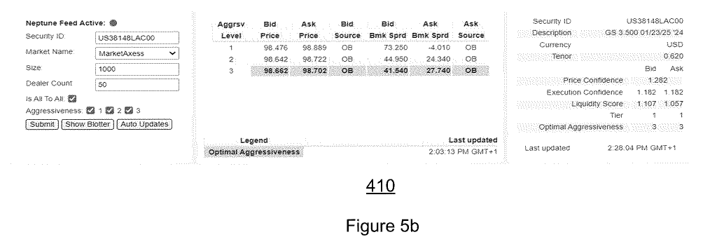

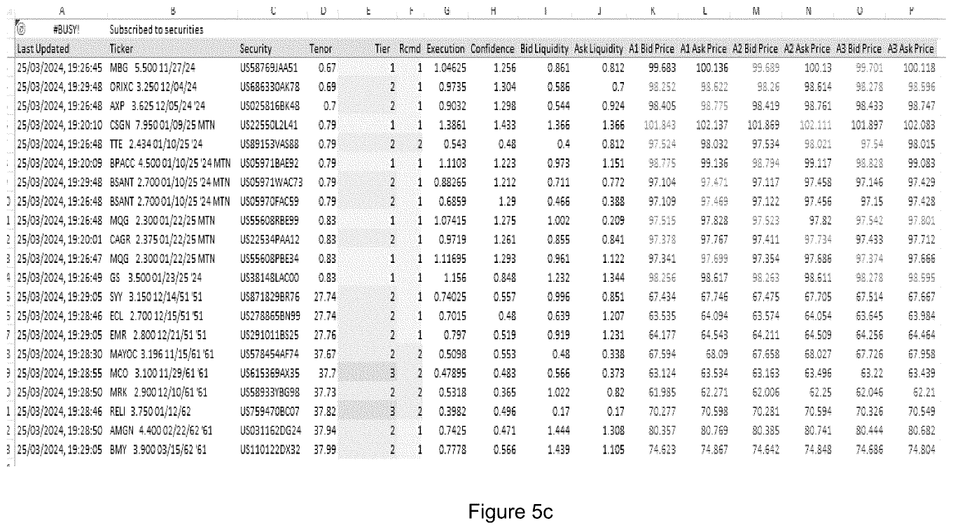

FIG. 5a with partial views FIGS. 5a (i) and 5a (ii) shows a user interface 400 with results as presented to a trade in which the columns “Margin Bid (M)” 402 and “Margin Ask (M)” 404 are composed of the “distance to Bid (M)” 406 and “distance to Ask (M)” 408, respectively, on top of the COBI priced “Bid” and “Ask” quotes for each bond.

FIG. 5b shows a user interface 410 of the RFQ viewer for viewing the layer 2 responses and invokes an API request when the user clicks submit. FIG. 5c shows a portfolio view, where users can see streaming layer 1 prices.

The pricing module 40 thus automates trade flow and margin optimization, preserves optimal hit ratio and significantly increases desk P&L. Beneficially, trading desks can create a desk-specific proprietary consolidated data tape by aggregating historical and live data from multiple sources; trading desks can fully automate at least 30% of their RFQs and execute an additional at least 20% with trader supervision; trading desks can respond to 80% to 120% more RFQs; bond trading execution desk revenue can be grown significantly; COBI-Pricing enables the creation of various curve visualizations and front-end trade analytics tools that are natively integrated with trader's desktop; dealers can boost their RFQ hit ratio with the margin optimization model add-on; COBI-Pricing liquidity modeling allows the trading desks to determine the liquidity of little-traded bonds, construct liquidity profiles for holdings and monitor liquidity; traders can predict investor behaviour with buy/sell indicators; and traders can predict bond issuance probabilities.

In an example of a buy side offering, the system 10 provides a smart order routing module 46 order having instructions executable by the processor 14 to determine an optimal execution route given current market conditions by analyzing historical lookback data, current dealer axes, total market capacity and contemporaneous data, and to select an optimal dealer to engage for the financial instrument under current market conditions. For example, the smart order routing module 46 for the Credit Markets comprises unique features such as implied firmness, total market capacity & dealer inventory.

When a Buy side trader needs to execute a large order, the trader has the freedom to split orders across multiple Sell side desks. As such, the smart order routing module 46, with AI enhanced routing logic, maximises execution probability and gives the trader full visibility of how the order will be broken down.

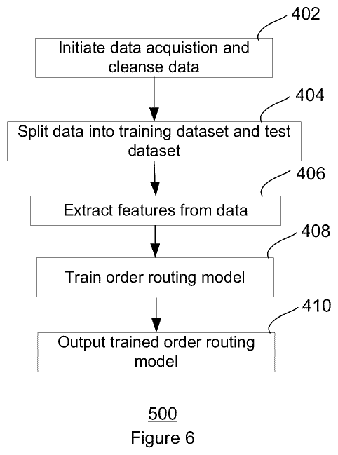

FIG. 6 shows a flow chart 500 outlining exemplary steps for constructing a smart order routing model of the order routing module 46. In step 402, total market capacity (TMC), dealer inventory; TCA lookback data and live market data, researched key market indicators, are aggregated and the aggregated data undergoes pre-processing for data cleansing. Where firmness in a particular size is directly indicated (for example on All to All trading platforms), this is used directly, however when the size is unknown (for example via RFQ), then it can be modelled based on past dealer performance in similar bonds and current positioning/pricing.

Generally, TMC is reached when there is the quantity of a particular bond readily available in the market is insufficient to fill a trade. As such, TMC is the portion of the outstanding amount of a bond not tied up by buy-and-hold accounts unwilling to trade. Sell side Traders are likely to alter their margin for trade sizes beyond approaching TMC and this increases the transaction costs for Buy side firms.

Any change in dealer inventory may be modelled by the order routing module 46 by tracking daily trade volumes from sources such as TRACE (and looking back over a six month period). This feeds into the firmness calculation and allows the model to adjust the likelihood of achieving the screen price when the street is net the same way as the desired order (i.e. if the client is looking to sell and dealers are already net long, then the execution probability would be lower than if the street was net short).

The TCA lookback data comprises historical data within a predefined period. In one example, the historical data includes 2 years worth of real world executed trades unique to the client, and the model learns which dealers are most likely to respond aggressively on the particular bond by considering their performance on similar bonds (and the exact ISIN in question).

In step 404, the data is split into a training dataset, and a test dataset, and feature extraction ensues in step 406, followed by model training in step 408. To train for TMC, learning and prediction are applied to six or more months of historical data to bridge data delays and discern trade size and volume patterns.

The trained routing model is outputted in step 410. In operation, the order routing module 46 provides a number of outputs that enable the trader to visualize the optimal execution routing, such as a) execution probability b) optimal chunking and c) optimal timing.

With respect to execution probability, different execution venues have differing protocol's, for example an All to All platform will typically consist of an order book with firm orders (i.e. a fixed price for a specific size, good until a specific time or until cancelled). However, not all execution routes are equally, if trading via RFQ for example it can be difficult for a Buy side trader to know whether the Sell side dealer will significantly move the price for a size larger than that indicated (or even for the indicated size). By calculating the implied firmness (or taking the actual firmness if available), the order routing module 46 can then determine an execution probability for the given size, price target and timeframe combination.

Historically Buy side traders have been reluctant to split orders up into smaller pieces and execute across multiple dealers and venues. Feedback suggests that due to increasing liquidity constraints there is now a much greater willingness amongst Buy side participants to split orders up into multiple chunks. Within the constraints set by the trader, the order routing module 46 splits the order up into optimal chunks (for example a USD 10 million order could be split into 3 chunks, 2 million via an All to All platform with a firm bid and 2×4 million via RFQ platforms, specifically inviting dealers who are likely to be active in the credit and have historically provided good liquidity to the client.

Price can be paramount for any trader, however there are occasions when immediate execution at the desired price isn't viable in the size requested. The order routing module 46 may suggest times when it may be more suitable to place a passive order (e.g. by placing a sell order at the target price via an All to All platform, rather than hitting a bid lower than desired).

In one example, the system 10 may include a front-end interface which incorporates side by side visualization of a calibrated intra-day COBI pricing model and a Build Plan output by the order routing module 46, and the intermediate results may be delivered based on live size/price information, confidence level of the modeled price, liquidity score, timescale and implied firmness; and the features may include total market capacity, dealer inventory and leading indicators. The margin optimization model may be trained on a two-year record of the Buy side firm's historic executions, and results of the margin optimization model include the best executable price determined by the predictive pricing model.

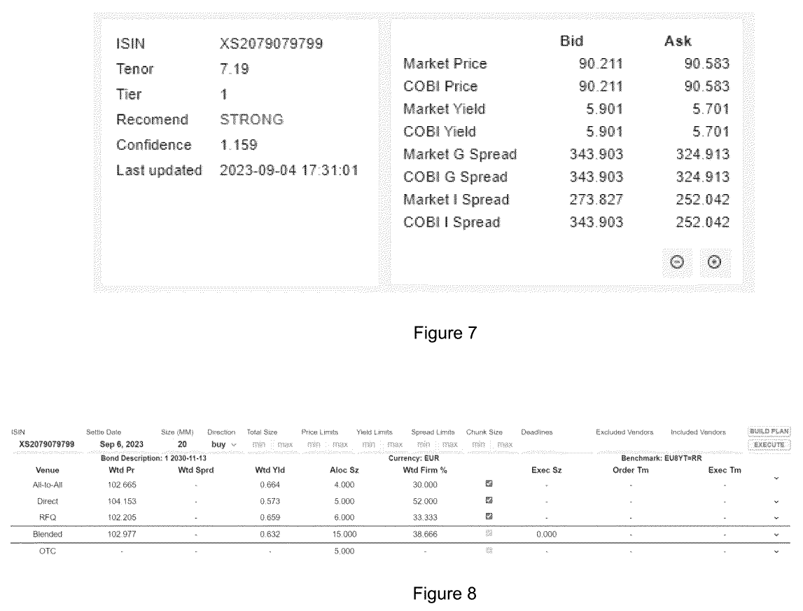

The system 10 may return all results via an API, or users can see the routing options on the user interface, as shown in FIG. 7.

FIG. 8 shows example results that may be presented to a user or trader via a user interface.

Users can see key information about the bond (such as current price, yield and the execution score) prior to building an execution plan. Once the execution plan has been created, traders can adjust parameters, remove specific venues or even complete execution routes (e.g. exclude All to All platforms). The weighted price (and other columns) can be expanded to see a full line by line (one line per routing option) breakdown. Additionally if there is insufficient electronic liquidity available, the algorithm will return a list of dealers to approach, based on a TCA lookback specific to the Buy side firm in question.

In one example, back testing of the pricing model, margin optimization model is performed against historical data comprising approximately 2.5 years of trade history associated with a client. The models were trained a model on part of the data (approximately 2 years worth), and the remaining 6 months worth of data was used to produce the results (by ensuring data the model has not seen before is used to produce the results, overfitting, i.e. producing an artificially strong result can be avoided). The aim of the model was to predict the likely price quoted by a dealer responding to an incoming RFQ. By predicting the response for a given price and size (against a specific ISIN at a given timestamp) opportunities to optimise execution efficiency can be observed. The output would also highlight a subset of trades that could be optimised and transaction costs lowered. The back test discussion refers to the price confidence score; liquidity bid score; liquidity ask score; execution score; tier e.g. tier 1; tier 2; tier 3, as defined under the DEFINITIONS heading above.

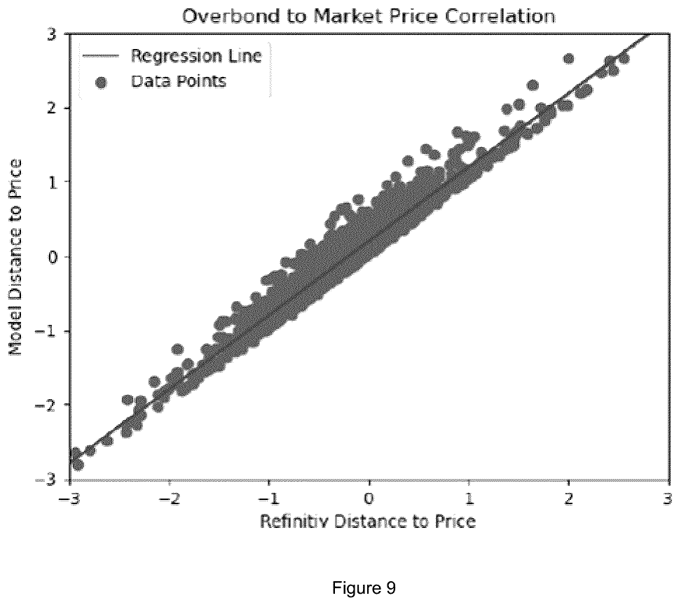

A layer 2 pricing model predicts the price a dealer will provide on an incoming RFQ, and is trained on transaction data, non-binding quote data and firm quote data, as defined under the DEFINITIONS heading above. From a Buyside perspective this allows Buyside traders to gauge whether their price & size targets are realistic for the current market conditions. FIG. 9 shows highlights a very strong (0.98) correlation between the pricing model and observed market pricing. By considering the difference between the model and the actual traded price against the difference between the timestamp matched ‘market’ price and the actual traded price it is possible to see the correlation between the model and market pricing. Generally, when Client X sells Distance to Price, the predicted sell price=(Model Price or Refinitiv Bid Price)−Client X Price; and when Client X buys Distance to Price, the predicted buy price=Client X Price−(Model Price or Refinitiv Ask Price).

In one example, the target is the cover-price divided by the sector median bid-ask spread, thereby capturing the sector/market risk. For example, the sector/market risk may be captured by firstly, using non-binding quote data to calculate sector bid-ask spread and infer the market conditions. Accordingly with the knowledge of how the market bid-ask spread behaves over time and the market's bid-ask spread can be compared with the model's security's bid-ask spread. If there is any change in the market level bid-ask spread, that change should be seen across other securities within that sector. By doing this, the market level risk is incorporate in the predicted pricing.

Similarly, different levels of risk are captured through other features that are discussed below. For example—issuer median spread may be used to understand any issuer level changes. By approximating the potential risk, the spread and the factors that affect the price may be identified. The overall risk is estimated using the formula below:

Risk=Country risk+Market risk+Issuer risk+Issue risk→Spread change
where Country risk may include Brexit: Barclays, HSBC, RBS—Spread wider in USD/BOA, JP Morgan, Citi-Spread remained similar; Inputs: Government rate: 1d, 7d, 30d, 60d change; Market risk may include world events, such as an oil crisis, in which the energy sector spread jumped; inputs: median spread, median number of quote at sector level; Issuer risk: Company's credit rating change, performance Inputs: yield volatility, credit rating, quotes at issuer level; and Issue risk—e.g. bond specific risk, more impact of rate shock on long term tenor; Inputs: tenor, callable (in/at/out-of-the money), seniority, quotes, volatility.

In Table 6 below, 1,465,591 unique data points with 94,559 unique ORDER IDs can be seen, however in order to ensure the training data is suitable for this specific backtest it must be cleansed as follows:

TABLE 6

| STATUS | TRADES REMAINING |
|---|---|
| Total rows in the dataset | 94,559 |
| Total rows in the dataset 94,559 | 57,052 |
| USD only | 39,148 |
| Senior unsecured only | 34,410 |
| Corporate bonds only | 20,504 |
| Removing RFQ before issue date | 20,313 |
| PRICE better than 2ndbest price | 19,167 |

Accordingly, 19,167 trades suitable for training and testing remain following the data cleanse, however, to ensure the model is tested on a subset of this, and minimize overfittting (and produce artificially high results), additional trades are used for testing (e.g. 3,374 trades from Q1 2023 and Q2 2023) and the remainder for training, as can be seen in Table 7.

TABLE 7

| STATUS | TRADES REMAINING |
|---|---|
| Total trades in Q1 and Q2 of 2023 | 3,374 |
| Removing trades with no quote in past 24 | 2,406 |
| hours or price outlier | |

Next, 968 of the 3,374 trades are removed because they were either missing model features due to not having a quote in the last 24 hours or were considered to be an outlier. In order to ensure price anomalies (which could drastically skew the results), outliers are identified and removed. Generally, a data point is classified as an outlier when the difference between the accepted price and Refinitiv composite mid price is 5 times higher than Refinitiv bid (ask)-mid difference or in absolute terms the difference is greater than $1.5. As part of the validation process, only executed trades are included, Therefore, 2,406 trades are left for the backtest analysis.

Table 8 shows the high-level results of the backtest analysis.

TABLE 8

| | | Median | | | |
|---|---|---|---|---|---|
| | | | | Overbond | Overbond |
| | | Client X | Overbond | (Conservative) | (Aggressive) |
| | | Distance | Distance | Distance | Distance |
| Tier | Count | to Mid | to Mid | to Mid | to Mid |
| 1 | 759 | 0.0480 | 0.0251 | 0.3029 | −0.3740 |
| 2 | 1,455 | 0.0695 | 0.0509 | 0.5334 | −0.4658 |
| 3 | 192 | 0.0697 | 0.0595 | 0.4825 | −−0.5028 |

Distance to mid is the difference between Client X/Model Price and Refinitiv RTO mid price, therefore:

When Client X sells Distance to mid=Mid Price−(Client X or Model Price)

When Client X buys Distance to mid=(Client X or Model Price)−Mid Price; a positive Distance to mid means that the price was below mid (weaker execution), while a negative Distance to mid means that the price was through the mid (stronger execution). The final two columns show the Overbond model's distance to mid for both aggressive and conservative pricing (which can simulate axed or defensive dealer responses). From Table 8, it can be seen that Distance to Mid trends are wider as one goes from Tier 1 to Tier 3 for both the Overbond Model and Client X's actual trades.

Table 9 below shows the count of actual trades bucketed by distance to mid (in dollar terms). If the RFQ has a negative distance to mid, then the trade took place above the mid and Client X already achieved good quality execution (e.g. if a buy is showing a negative value then the offer was lower than mid and the reverse for a sell). The trades highlighted in yellow were all categorized as Tier 2 or 3 at the time of the trade, however as liquidity changes throughout the day they have potential to tick up to Tier 1 or 2 respectively.

TABLE 9

| | Client X | | | | | | |
|---|---|---|---|---|---|---|---|
| Tier | Side | <−0.25 | −0.15 | −0.1 | 0-0.1 | 0.1-0.25 | >0.25 |
| 1 | BUY | 114 | 97 | 104 | 132 | 113 | 199 |
| | SELL | 320 | 171 | 150 | 134 | 199 | 481 |
| 2 | BUY | 49 | 18 | 18 | 18 | 20 | 69 |
| | SELL | 114 | 97 | 104 | 132 | 113 | 199 |
| 3 | BUY | 320 | 171 | 150 | 134 | 199 | 481 |
| | SELL | 49 | 18 | 18 | 18 | 20 | 69 |

In one implementation, processing circuitry 14 may be embodied as a multi-core processor, a single core processor, or a combination of one or more multi-core processors and one or more single core processors. For example, processing circuitry 14 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, Application-Specific Standard Products (ASSPs), System-on-a-chip systems (SOCs), Complex Programmable Logic Devices (CPLDs), Programmable Logic Controllers (PLC), Graphics Processing Units (GPUs), and the like. For example, some or all of the device functionality or method sequences may be performed by one or more hardware logic components.

Memory 16 may be embodied as one or more volatile memory devices, one or more non-volatile memory devices, and/or a combination of one or more volatile memory devices and non-volatile memory devices. For example, memory 16 may be embodied as magnetic storage devices (such as hard disk drives, floppy disks, magnetic tapes, etc.), optical magnetic storage devices (e.g., magneto-optical disks), CD-ROM (compact disc read only memory), CD-R (compact disc recordable), CD-R/W (compact disc rewritable), DVD (Digital Versatile Disc), BD (BLU-RAY™ Disc), and semiconductor memories (such as mask ROM, PROM (programmable ROM), EPROM (erasable PROM), flash ROM, RAM (random access memory), etc.).

The communication interface enables computing system 12 to communicate with other entities over various types of wired, wireless or combinations of wired and wireless networks, such as for example, the Internet. In at least one example embodiment, the communication interface includes a transceiver circuitry configured to enable transmission and reception of data signals over the various types of communication networks. In some embodiments, communication interface may include appropriate data compression and encoding mechanisms for securely transmitting and receiving data over the communication networks. Communication interface facilitates communication between computing system 12 and I/O peripherals.

It is noted that various example embodiments as described herein may be implemented in a wide variety of devices, network configurations and applications.

Those of skill in the art will appreciate that other embodiments of the disclosure may be practiced in network computing environments with many types of computer system configurations, including personal computers (PCs), industrial PCs, desktop PCs), hand-held devices, multi-processor systems, microprocessor-based or programmable consumer electronics, network PCs, server computers, minicomputers, mainframe computers, and the like. Accordingly, system 10 may be coupled to these external devices via the communication, such that system 10 is controllable remotely. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

In another implementation, system 10 follows a cloud computing model, by providing an on-demand network access to a shared pool of configurable computing resources (e.g., servers, storage, applications, and/or services) that can be rapidly provisioned and released with minimal or nor resource management effort, including interaction with a service provider, by a user (operator of a thin client).

The benefits and advantages described above may relate to one embodiment or may relate to several embodiments. The embodiments are not limited to those that solve any or all of the stated problems or those that have any or all of the stated benefits and advantages. The operations of the methods described herein may be carried out in any suitable order, or simultaneously where appropriate. Additionally, individual blocks may be added or deleted from any of the methods without departing from the spirit and scope of the subject matter described herein. Aspects of any of the examples described above may be combined with aspects of any of the other examples described to form further examples without losing the effect sought.

The above description is given by way of example only and various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises,” “comprising,” or any other variations thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical.”

The preceding detailed description of exemplary embodiments of the invention makes reference to the accompanying drawings, which show the exemplary embodiment by way of illustration. While these exemplary embodiments are described in sufficient detail to enable those skilled in the art to practice the invention, it should be understood that other embodiments may be realized and that logical and mechanical changes may be made without departing from the spirit and scope of the invention. For example, the steps recited in any of the method or process claims may be executed in any order and are not limited to the order presented. Thus, the preceding detailed description is presented for purposes of illustration only and not of limitation, and the scope of the invention is defined by the preceding description, and with respect to the attached claims.

1. A computer system comprising:
one or more processor units, and a memory device comprising memory space with computer-executable instructions;
a data preparation module comprising computer-executable instructions configured to aggregate raw data and normalize the raw data to generate at least one structured dataset;
a pricing module comprising computer-executable instructions configured to determine a first set of features from the at least one structured dataset, the pricing module applying a machine learning architecture to train a set of predictive pricing models to generate an indication in electronic form representing at least one optimal pricing of at least one financial instrument;
a margin optimization module comprising computer-executable instructions configured to determine a second set of features from the at least one structured dataset, the margin optimization module applying the architecture machine learning architecture to train a set of predictive models to minimize a transaction margin for the at least one financial instrument based on one of the at least one of the second set of features and at least one optimal pricing of at least one financial instrument; and
wherein the one or more processor units, and the memory device are configured to write an indication to the memory space to at least communicate the at least one optimal pricing and the transaction margin of the at least one financial instrument via a communication network and/or generate a visual indicator related to and based at least in part on the generated indication on a graphical user interface.

2. The computer system of claim 1, wherein the raw data comprises financial data associated the at least one financial instrument, wherein the financial data comprises at least one of market spread/price movements, dealer quotations/composite quotes, company credit ratings, macro-market data, industry sector comparables, settlement data, trade reporting data and proprietary data.

3. The computer system of claim 2, wherein when requesting a streaming quote using a streaming model, the financial data comprises a security identifier, and wherein when requesting an invocation quote using an invocation model, the financial data comprises a security identifier, trade size, trade venue, dealers in competition.

4. The computer system of claim 3, wherein the financial data comprises at least one of an indication of whether the quote is broadcast to a plurality of participants or a select participant list, and an indication whether an existing axe is in place for selling.

5. The method of claim 1, wherein one or more processor units extract at least one feature vector set from the at least one structured dataset for input into the machine learning architecture.

6. The computer system of claim 4, wherein the one of the at least one of the second set of features comprises at least one of a bid/ask spread; tenor; number of dealer competitors; and trade size.

7. The method of claim 4, wherein the machine learning architecture comprises a neural network comprising at least one at least one learning algorithm.

8. The computer system of claim 7, wherein the invocation model comprises gradient boosting and incremental learning whilst the streaming model comprises gradient boosting.

9. The computer system of claim 1, wherein the at least one financial instrument is at least one of a bond, a security, a currency, and an ETF.

10. A computer system configured for automating trading of at least one financial instrument, the computer system comprising:
one or more processor units, and a memory device comprising memory space with computer-executable instructions, wherein the computer-executable instructions configured to at least:
receive an order to purchase the least one financial instrument;
determine a price confidence score associated with the least one financial instrument;
determine a liquidity bid score associated with the least one financial instrument;
determine a liquidity ask score associated with the least one financial instrument;
determine an execution score associated with the least one financial instrument; and
assign the at least one financial instrument to one of a plurality of tiers based on at least one of the price confidence score, liquidity bid score, liquidity ask score and execution score, wherein one of the plurality of tiers includes the at least one financial instrument that is suitable for automated trading and another one of the plurality of tiers includes the at least one financial instrument that is not suitable for automated trading.

11. The computer system of claim 10, wherein the price confidence score is indicative of a degree of confidence that an execution at a current predicted bid or ask price would lead to an optimal outcome, without adjusting for liquidity conditions.

12. The computer system of claim 10, wherein the liquidity bid score is indicative of a degree of confidence that an execution at the current predicted bid price would lead to an optimal outcome, based on bid-side liquidity conditions.

13. The computer system of claim 12, wherein the execution score is indicative of a degree of confidence that an execution at the current predicted bid or ask price would lead to an optimal outcome, derived by taking a dynamically weighted average of the price confidence score and the liquidity scores.

14. The computer system of claim 12, wherein the liquidity ask score is indicative of a degree of confidence that an execution at the current predicted ask price would lead to an optimal outcome, solely based on ask-side liquidity conditions.

15. The computer system of claim 12, wherein the computer-executable instructions configured to at least:
initiate an acquisition of raw financial transaction data associated with the at least one financial instrument;
pre-process the raw financial transaction data to generate a training dataset and test dataset for training and testing predictive pricing models to output a trained predictive pricing models, and for training and testing confidence models to output a trained confidence models.

16. The computer system of claim 15, wherein the trained predictive pricing model predicts the current predicted bid or ask price.

17. The computer system of claim 15, wherein the trained confidence model determines the price confidence score, liquidity ask score, the liquidity bid score, and the execution score.

18. The computer system of claim 17, wherein settlement-layer data is fed into the trained confidence model to auto-adjust at least one of the price confidence score, liquidity ask score, the liquidity bid score, and the execution score for increased accuracy.

19. The computer system of claim 18, wherein trades are allocated based on at least one of trade size, liquidity, volatility, level of automation and price aggressiveness level.

20. The computer system of claim 19, wherein trades are allocated by an order routing algorithm having instructions executable by the one or more processor units to at least:
determine an optimal execution route given current market conditions by analyzing at least one of historical lookback data, current dealer axes, total market capacity and contemporaneous data, and select an optimal dealer to engage for the at least one financial instrument under current market conditions.
